(19) United States
(12) Patent Application Publication
(10) Pub. No.: US 2021/0382440 A1
(43) Pub. Date: Dec. 9, 2021

(54) Time and Date Display Device

(71) Applicant: Candace Williams, Jacksonville, FL (US)

(72) Inventor: Candace Williams, Jacksonville, FL (US)

(21) Appl. No.: 17/337,878

(22) Filed: Jun. 3, 2021

Related U.S. Application Data
(60) Provisional application No. 63/035,042, filed on Jun. 5, 2020.

(51) Int. Cl. G04C 17/00; G04G 9/00; G04G 17/04

(52) U.S. Cl. CPC G04C 17/0091; G04G 9/0082; G04B 19/04; G04G 17/045; G04G 9/0064

(57) ABSTRACT

A time and date display device is provided. The device includes a housing having a power source therein. A plurality of discrete displays is disposed across a front face of the housing, wherein the plurality of discrete displays is operably connected to the power source. The plurality of discrete displays includes an analog time display, a digital time display, and a date display. In some embodiments, a plurality of feet is disposed on a rear face of the housing.

### CROSS REFERENCE TO RELATED APPLICATIONS

This application claims the benefit of U.S. Provisional Application No. 63/035,042 filed on Jun. 5, 2020. The above identified patent application is herein incorporated by reference in its entirety to provide continuity of disclosure

### BACKGROUND OF THE INVENTION

The present invention relates to timepieces and docks. More particularly, the present invention pertains to a timepiece having a plurality of discrete displays providing the time and date in a variety of formats.

Many individuals, particularly children, may have difficulty reading the time on traditional analog clocks, as digital clocks have become more prevalent and pervasive. Particularly, many people rely on smartphones or other electronic devices to determine the current date and time, as well as for automatically determining time changes due to travelling across time zones or as a result of daylight savings adjustments. As education regarding reading analog clocks has fallen behind for many children, they may have difficulty determining the time when unable to consult their electronic devices. Therefore, a device that simultaneously displays the time and date in analog and digital formats to aid children and other individuals in reading analog time is desired.

In light of the devices disclosed in the known art, it is submitted that the present invention substantially diverges in design elements from the known art and consequently it is clear that there is a need in the art for an improvement to existing time and date display devices. In this regard, the instant invention substantially fulfills these needs.

### SUMMARY OF THE INVENTION

In view of the foregoing disadvantages inherent in the known types of time and date display devices now present in the known art, the present invention provides a display device wherein the same can be utilized for providing convenience for the user when determining the current time and date in either an analog or digital format.

The present system comprises a housing having a power source disposed therein. A plurality of discrete displays is disposed across a front face of the housing, wherein each of the plurality of discrete displays are operably connected to the power source. The plurality of discrete displays includes an analog time display, a digital time display, and a date display. In some embodiments, a plurality of feet is disposed on a rear face of the housing, wherein the plurality of feet is configured to retain the housing on a support surface.

In some embodiments, a mounting aperture is disposed on the rear face of the housing. In another embodiment, the power source is removably securable within a compartment defined through a rear face of the housing. In other embodiments, a door is removably securable over the compartment. In yet another embodiment, the housing comprises a plurality of linear portions affixed together. In some embodiments, each of the plurality of linear portions includes one of the plurality of discrete displays thereon. In another embodiment, the front face is disposed along a plane parallel to a plane of the rear face of the housing. In other embodiments, the front face is disposed at an angle relative to a plane of the rear face of the housing, such that a height of a front side of the housing is less than a height of the rear side of the housing. In yet another embodiment, a plurality of controls is configured to selectively adjust a time and a date displayed by each of the plurality of discrete displays. In some embodiments, the front face extends between each of the plurality of discrete displays, such that each discrete display is isolated. In another embodiment, the plurality of feet is composed of rubber.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the time and date display device.

FIG. 1B shows a perspective view of an alternate embodiment of the time and date display device.

FIG. 2 shows a rear view of an embodiment of the time and date display device.

FIG. 3 shows a schematic view of an embodiment of the time and date display device.

### DETAILED DESCRIPTION OF THE INVENTION

Reference is made herein to the attached drawings. Like reference numerals are used throughout the drawings to depict like or similar elements of the time and date display device. The figures are intended for representative purposes only and should not be considered to be limiting in any respect.

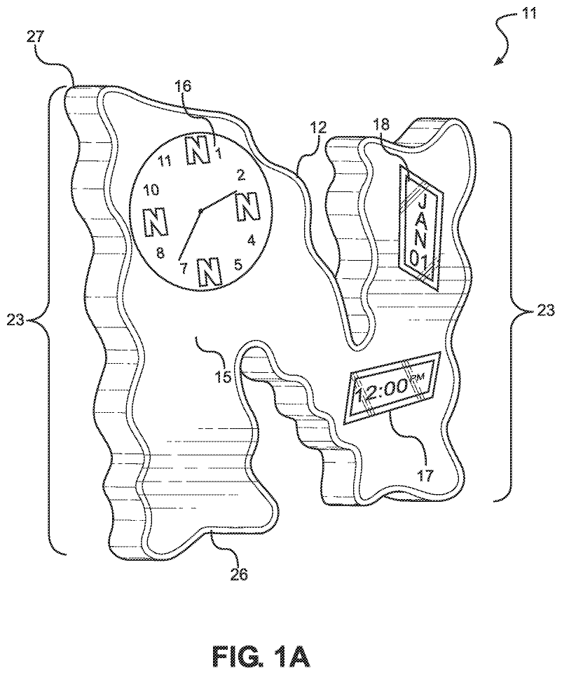

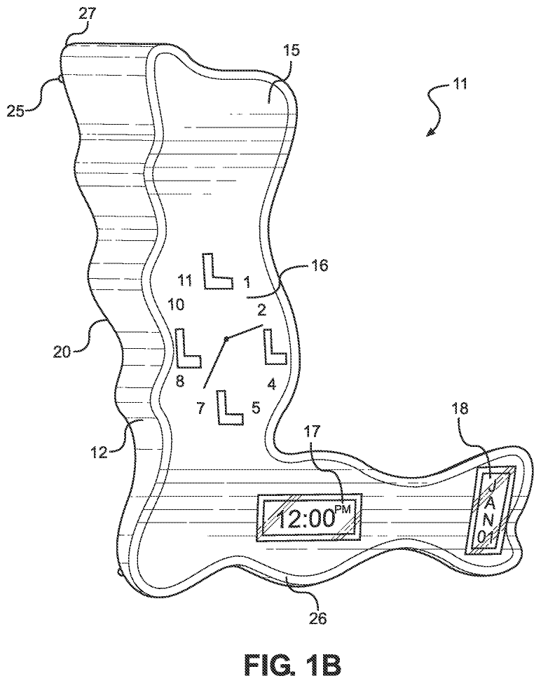

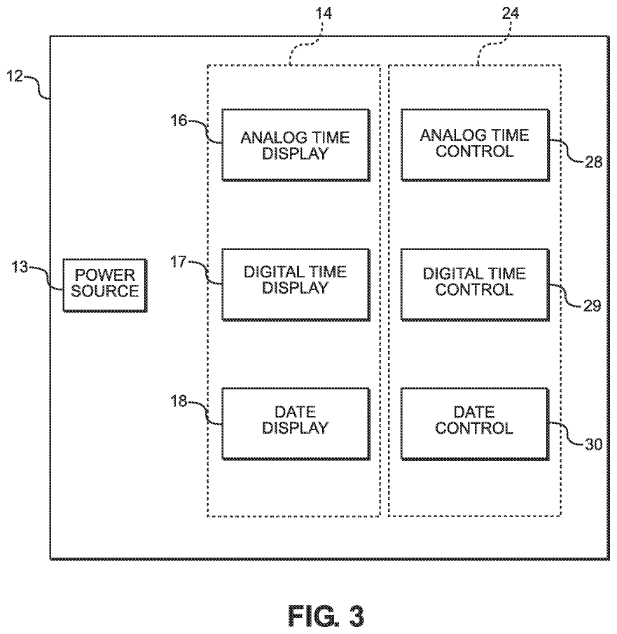

Referring now to FIGS. 1A and 1B, there is shown a perspective view of an embodiment of the time and date display device and a perspective view of an alternate embodiment of the time and date display device, respectively. The time and date display device 11 comprises a housing 12 having a plurality of discrete displays (as shown in FIG. 3, 14) across a front face 15 of the housing 12, wherein the plurality of discrete displays is operably connected to a power source disposed within the housing 12. The plurality of discrete displays includes an analog time display 16, a digital time display 17, and a date display 18. In some embodiments, the analog time display 16 and the digital time display 17 are operably connected, such that each of the analog and digital time displays 16, 17 display the same time. In this manner, as the displayed time is adjusted on one of the analog or digital time displays 16, 17, the displayed time on the remaining analog or digital time display 16, 17 is automatically adjusted. In such cases, this can expedite the length of time required to teach children how to read an analog clock, as the user can adjust the time displayed on the digital time display 17 and compare it to the resulting time displayed on the analog time display 16. In some embodiments, a plurality of controls (as shown in FIG. 3, 24) is disposed on the housing 12, wherein the plurality of controls is operably connected to each of the plurality of discrete displays, such that the time and date displayed by each of the plurality of discrete displays can be selectively adjusted via actuation of the plurality of controls. In some such embodiments, the plurality of controls can be positioned on the front face 15 of the housing 12 to provide ease of access for the user. Alternatively, the plurality of controls is disposed on a rear face 20 of the housing 12 in other embodiments, such that the plurality of controls is hidden from view while the date and time display device 11 is in use. In this manner, the user can maximize the aesthetic appearance of the time and date display device 11 during use. Furthermore, in some embodiments, a decorative element, pattern, or scalloping can be present along a border of the housing 12 as preferred by the user. In this manner, the time and date display device 11 can be personalized to suit a desired aesthetic preference.

In the shown embodiments, the front face 15 extends between each of the plurality of discrete displays such that each discrete display of the plurality of discrete displays is isolated. In this manner, the user can readily and freely distinguish between each of the plurality of discrete displays. Additionally, this allows the plurality of discrete displays to be positioned along the housing 12 in an aesthetically pleasing pattern. In the shown embodiments, the housing 12 further comprises a plurality of linear portions 23 affixed to each other in an end-to-end fashion to form various desired shapes. For example, the housing 12 can comprise one or more linear portions 23 to define letters of the alphabet (such as an “N” shown in FIG. 1A and an “L” shown in FIG. 1B), such that the time and date display device 11 can be personalized to correspond to an intended user's name. In such embodiments, each discrete display of the plurality of discrete displays can be positioned on each of the plurality of linear portions 23, such that the plurality of discrete displays is readily identifiable.

In the illustrated embodiment of FIG. 1A, the housing 12 comprises a front face 15 disposed along a plane parallel to a plane of the rear face 20, such that the front face 15 is readily visible when the housing 12 is supported on a substantially vertical wall surface. Alternatively, in the embodiment of FIG. 1B, the front face 15 is disposed at an angle relative to the rear face 20 of the housing 12, such that a front side 26 of the housing comprises a height less than a height of a rear side 27 of the housing 12. In this manner, the front face 15 is readily visible when the housing 12 is resting on a horizontal support surface, such as a desk surface. In such embodiments, a plurality of feet 25 are disposed on the rear face 20, wherein the plurality of feet 25 elevate the housing 12 and secure the housing 12 to the support surface. In some embodiments, the plurality of feet 25 comprise a rubber or other high friction material configured to prevent the housing 12 from shifting during use.

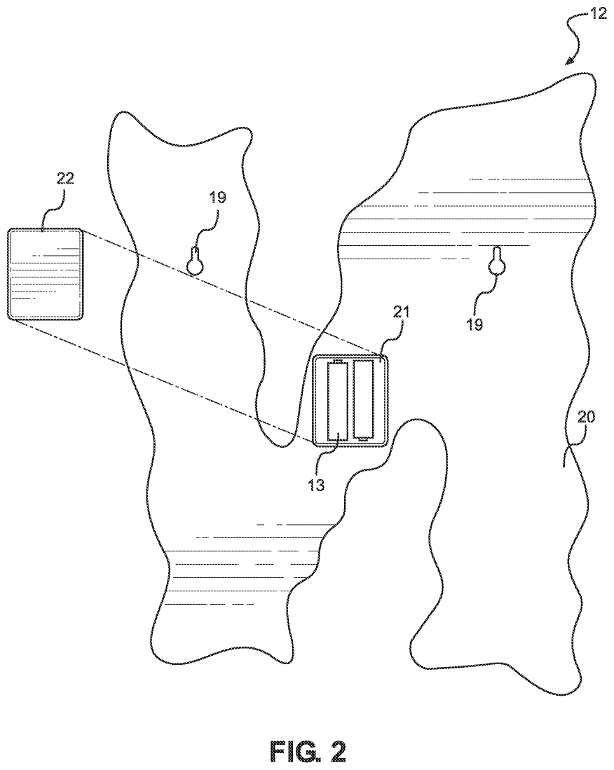

Referring now to FIG. 2, there is shown a rear view of an embodiment of the time and date display device. In the illustrated embodiment, a compartment 21 is disposed through the rear face 20 of the housing 12, wherein the compartment 21 removably receives the power source 13 therein. In the shown embodiment, the power source 13 comprises a one or more batteries, however, in alternate embodiments, the power source 13 is contemplated to include an external power source connected to the housing 12 via at least one cable. In the illustrated embodiment, a door 22 is removably securable over the compartment 21, such that the power source 13 can be retained therein. In some such embodiments, the door 22 includes one or more spring-biased latch members configured to retain the door 22 within the compartment, however, in alternate embodiments, the door 22 is secured to the housing 12 via one or more fasteners securable thereto. In the illustrated embodiment, the rear face 20 further comprises one or more mounting apertures 19 therein, wherein the mounting apertures 19 are configured to receive a mounting fastener to secure the housing 12 to a support surface. In the shown embodiment, a width of the mounting aperture 19 decreases from a lower end thereof towards an upper end thereof. In this manner, the mounting fastener is retained within the narrower upper end, such that the housing 12 is retained on the support surface. In the shown embodiment, the mounting apertures 19 are evenly dispersed across an upper end of the housing 12, such that the weight of the housing 12 is distributed across the multiple mounting apertures 19.

Referring now to FIG. 3, there is shown a schematic view of an embodiment of the time and date display device. In the illustrated embodiment, each of the plurality of discrete displays 14 is operably connected to an independent control of the plurality of controls 24, such that each discrete display is separately adjustable. In the shown embodiment, the analog time display 16 is operably connected to an analog time control 28, the digital time display 17 is operably connected to a digital time control 29, and the date display 18 is operably connected to a date control 30. Each of the plurality of controls 24 can comprise buttons, dials, touchscreens, or other desired control mechanisms. In some embodiments, the analog time control 28 and the digital time control 29 are linked, such that adjusting the digital time display 17 automatically adjusts the analog time display 16 and vice versa. In this manner, the user can expedite the learning process by comparing the analog and digital time displays 16, 17. Each of the plurality of controls 24 and the plurality of discrete displays 14 is further operably connected to the power source 13 disposed within the housing 12.

In one use, the housing 12 can be secured to a desired support surface, such as a wall, desk, or the like. In wall mounted embodiments, the mounting fastener can be inserted into the mounting aperture on the rear face of the housing 12, whereas desk embodiments can be rested on the support surface such that the plurality of feet support, elevate, and retain the housing 12 in a desired position. The user can actuate the plurality of controls 24 to adjust the time and date displayed by the plurality of discrete displays 14 to the current time. The user can then compare the time displayed on each of the analog time display 16 and the digital time display 17 to expedite the process of learning how to read an analog clock. Additionally, in some embodiments, as the user selectively adjusts the time displayed on the analog or digital time displays 16, 17, the time displayed on the remaining analog or digital time display 16, 17 is simultaneously adjusted. In this manner, the user can practice reading analog displays.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A time and date display device, comprising:
a housing having a power source disposed therein;
a plurality of discrete displays disposed across a front face of the housing, wherein each of the plurality of discrete displays are operably connected to the power source; and
wherein the plurality of discrete displays includes an analog time display, a digital time display, and a date display.

2. The time and date display device of claim 1, further comprising a mounting aperture disposed on a rear face of the housing.

3. The time and date display device of claim 1, wherein the power source is removably securable within a compartment defined through a rear face of the housing.

4. The time and date display device of claim 3, further comprising a door removably securable over the compartment.

5. The time and date display device of claim 1, wherein the housing comprises a plurality of linear portions affixed together.

6. The time and date display device of claim 5, wherein each of the plurality of linear portions includes one of the plurality of discrete displays thereon.

7. The time and date display device of claim 1, wherein the front face is disposed along a plane parallel to a plane of a rear face of the housing.

8. The time and date display device of claim 1, wherein the front face is disposed at an angle relative to a plane of a rear face of the housing, such that a height of a front side of the housing is less than a height of a rear side of the housing.

9. The time and date display device of claim 1, further comprising a plurality of controls configured to adjust a time and date displayed by each of the plurality of discrete displays.

10. The time and date display device of claim 1, wherein the front face extends between each of the plurality of discrete displays, such that each discrete display is isolated.

11. A time and date display device, comprising:
a housing having a power source disposed therein;
a plurality of discrete displays disposed across a front face of the housing, wherein each of the plurality of discrete displays are operably connected to the power source;
wherein the plurality of discrete displays includes an analog time display, a digital time display, and a date display; and
a plurality of feet disposed across a rear face of the housing.

12. The time and date display device of claim 11, further comprising a mounting aperture disposed on the rear face of the housing.

13. The time and date display device of claim 11, wherein the power source is removably securable within a compartment defined through the rear face of the housing.

14. The time and date display device of claim 13, further comprising a door removably securable over the compartment.

15. The time and date display device of claim 11, wherein the housing comprises a plurality of linear portions affixed together.

16. The time and date display device of claim 15, wherein each of the plurality of linear portions includes one of the plurality of discrete displays thereon.

17. The time and date display device of claim 11, wherein the front face is disposed along a plane parallel to a plane of the rear face of the housing.

18. The time and date display device of claim 11, wherein the front face is disposed at an angle relative to a plane of the rear face of the housing, such that a height of a front side of the housing is less than a height of a rear side of the housing.

19. The time and date display device of claim 11, further comprising a plurality of controls configured to adjust a time and date displayed by each of the plurality of discrete displays.

20. The time and date display device of claim 11, wherein the front face extends between each of the plurality of discrete displays, such that each discrete display is isolated.
